(19) United States
(12) Patent Application Publication
(10) Pub. No.: US 2026/0318380 A1
(43) Pub. Date: Oct. 15, 2026

(54) SEMI-ACTIVE TUNED MASS DAMPER WITH ADJUSTABLE STIFFNESS AND ADJUSTABLE DAMPING

(71) Applicant: DALIAN UNIVERSITY OF TECHNOLOGY, Dalian (CN)

(72) Inventors: Mingjie ZHANG, Dalian (CN); Haiyan YU, Dalian (CN); Fuyou XU, Dalian (CN); Tianyu WU, Dalian (CN); Bo WANG, Dalian (CN)

(21) Appl. No.: 19/678,779

(22) Filed: May 15, 2026

(30) Foreign Application Priority Data
Mar. 2, 2026 (CN) 202610242812.X

(51) Int. Cl. F16F 7/10; F16F 7/116

(52) U.S. Cl. CPC F16F 7/1017; F16F 7/116; F16F 2224/0208; F16F 2228/066

(57) ABSTRACT

The present invention belongs to the technical field of structural vibration control, and discloses a semi-active tuned mass damper with adjustable stiffness and adjustable damping. By connecting an adjustable damping element in parallel with an elastic element to form an elastic-damping combined component and then connecting the elastic-damping combined component in series with another elastic element, real-time and continuous adjustment of the equivalent stiffness of a TMD is achieved. Equivalent damping can be adjusted through the adjustable damping element. The damping element can be a magnetorheological damper or a controllable liquid viscous damper, and an output damping force can be changed respectively by applying a current or adjusting the permeability of a piston. The present invention has a wide adjustment range, a fast response, a low energy consumption, and can adapt to the changes in the natural frequency of a structure and the control requirements of multi-modal vibration.

### TECHNICAL FIELD

The present invention belongs to the technical field of structural vibration control, and relates to a semi-active tuned mass damper with adjustable stiffness and adjustable damping.

### BACKGROUND

A Tuned Mass Damper (TMD) is a typical structural vibration control device, which has been widely used in buildings, bridges and other flexible engineering structures to reduce wind-induced vibrations, human-induced vibrations, seismic responses and other structural dynamic responses caused by environmental excitation. A traditional TMD is typically composed of a mass block, an elastic element and a damping element, and the vibration reduction effect thereof depends on the precise tuning between the natural frequency of the device and the target vibration mode of a main structure.

However, during actual engineering service, the dynamic characteristics of the structure are often changed with environmental conditions, load levels and usage states. For example, factors such as temperature changes, added mass effects, material nonlinearity, and aerodynamic actions may all cause the drift of the natural frequency of the structure, thereby causing the traditional passive TMD to deviate from the optimal tuning state and significantly degrading the vibration reduction performance thereof.

In addition, the vibration response of an actual engineering structure usually has obvious multi-modal features. Taking a long-span bridge and a highly flexible structure as examples, the wind-induced vibrations and seismic responses thereof often involve multiple modes, and the dominance degrees of different modes in different working conditions may be changed. The traditional passive TMD with single-frequency tuning is difficult to meet the vibration control requirements of multiple target modes, and is prone to the situation that the TMD is effective for one mode but inadequate for controlling other modes. On this basis, semi-active tuned mass dampers with adjustable parameters and adaptability to multiple working condition changes and multiple modes have become an important research direction in the field of structural vibration control.

In the existing semi-active tuned mass damper technology, the implementation mode of adjustable damping has become relatively mature. By introducing intelligent damping elements such as a magnetorheological damper and a controllable liquid viscous damper, continuous or stepwise adjustment of a damping force can be achieved in the conditions of low energy consumption and good stability, thereby effectively enhancing the adaptability and robustness of the TMD in different working conditions. Therefore, semi-active tuned mass dampers with adjustable damping have been widely studied and verified in engineering applications and academic research.

In contrast, the research and engineering application of semi-active tuned mass dampers with adjustable stiffness are still in development stage. Most of the existing related technologies adopt mechanical construction methods to achieve stiffness adjustment. For example, stiffness adjustment within a limited range is achieved by changing the effective length of a spring, switching different combinations of elastic elements, or setting up an inclined spring and adjusting the inclination angle thereof. The above-mentioned solutions usually have the problems such as insufficient timeliness, complex structural form, large volume, and discrete or intermittent stiffness adjustment, which are difficult to meet the requirements of rapid and continuous stiffness adjustment in complex dynamic environments. In addition, the process of frequent mechanical switching may also introduce additional friction and wear, thereby reducing the long-term reliability and service stability of the device.

Previous studies have attempted to replace the damping element in the traditional passive TMD with an adjustable damping element. By adjusting the output characteristics of the damping element in real time, a positive or negative stiffness force can be equivalently generated at a dynamic response level, thereby achieving a semi-active tuned mass damper with adjustable stiffness. However, the equivalent stiffness adjustment range of such devices is usually quite limited, and as the adjustment amplitude of the equivalent stiffness is increased, a large equivalent damping is often introduced, thereby affecting the working efficiency.

Therefore, it is urgently necessary to propose a new technical solution with a simple structural form and a reasonable control mode, which can achieve real-time and continuous stiffness adjustment of a semi-active tuned mass damper within a wide range while maintaining the safety and stability of semi-active control, in order to make up for the deficiency of the existing semi-active tuned mass dampers in stiffness adjustability and further improve the vibration control effect thereof in complex working conditions and variable environmental conditions.

### SUMMARY

Aiming at the problems that the stiffness adjustment in the existing semi-active tuned mass dampers relies on mechanical structures, with insufficient timeliness and limited adjustment range, the present invention proposes a semi-active tuned mass damper with adjustable stiffness and adjustable damping. The device achieves the real-time, continuous and independent adjustment of the equivalent stiffness and damping parameters of the TMD through a reasonable combination of adjustable damping elements and elastic elements while maintaining the safety and stability of a semi-active control system, thereby improving the vibration control effect of the device in complex working conditions and in the condition of variable structural dynamic characteristics.

The semi-active tuned mass damper comprises a mass subsystem, an elastic subsystem and a damping subsystem. The mass subsystem is the same as a traditional TMD, and the mass thereof is denoted as m. The damping subsystem adopts a magnetorheological damper or a controllable liquid viscous damper, and the viscous damping coefficient thereof can be adjusted in real time, which is denoted as c̅₁ (the horizontal line above the parameter indicates that the parameter is a real-time adjustable parameter). The elastic subsystem is composed of two parts connected in series; the first part comprises elastic elements with a stiffness coefficient of k₁, and the second part is an elastic-damping combined component composed of elastic elements with a stiffness coefficient of k₂ and an adjustable damping element c̅₂ connected in parallel. By adjusting c̅₂ in real time, the dynamic characteristics of the elastic-damping combined component can be changed, thereby achieving real-time adjustment of the equivalent stiffness of the semi-active tuned mass damper. By adjusting c̅₁ in real time, the equivalent damping of the semi-active tuned mass damper can be adjusted in real time.

The technical solution of the present invention is as follows:
A semi-active tuned mass damper with adjustable stiffness and adjustable damping comprises a mass block 1, a first damping element 2, first elastic elements 3, a second damping element 4, second elastic elements 5, a connecting element 6 and a limit element 7;
The mass block 1 is used for providing a tuned mass and is connected with a controlled main structure through an elastic subsystem and a damping subsystem, and the mass block 1 can make a relative movement in a predetermined direction relative to the controlled main structure;
The first damping element 2 is arranged between the mass block 1 and the controlled main structure, is used as the damping subsystem of the semi-active tuned mass damper, and has a viscous damping coefficient adjustable in real time;
The elastic subsystem is composed of the first elastic elements 3, the second damping element 4 and the second elastic elements 5, and is arranged between the mass block 1 and the controlled main structure; the second damping element 4 and the second elastic elements 5 are connected in parallel to form an elastic-damping combined component; and the elastic-damping combined component is connected in series with the first elastic elements 3;
The connecting element 6 is arranged between the elastic-damping combined component and the first elastic elements 3 to achieve the connection between the two;
The limit element 7 is used for limiting the movement direction of the mass block 1 to prevent the mass block 1 from moving in an unexpected direction during vibration and ensure the operational safety of the semi-active tuned mass damper;
The equivalent stiffness coefficient k_{eq} and the equivalent damping coefficient c_{eq} of the semi-active tuned mass damper are respectively:

$${k}_{e q} = \frac{{k}_{1} [ {k}_{2} ( {k}_{1} + {k}_{2} ) + {( ω {\overline{c}}_{2} )}^{2} ]}{{( {k}_{1} + {k}_{2} )}^{2} + {( ω {\overline{c}}_{2} )}^{2}} \qquad ( 1 )$$

$${c}_{e q} = {\overline{c}}_{1} + \frac{{k}_{1}^{2} {\overline{c}}_{2}}{{( {k}_{1} + {k}_{2} )}^{2} + {( ω {\overline{c}}_{2} )}^{2}} \qquad ( 2 )$$

where k₁ and k₂ are respectively the stiffness coefficients of the first elastic elements 3 and the second elastic elements 5; c̅₁ and c̅₂ are respectively the viscous damping coefficients of the first damping element 2 and the second damping element 4, and are both adjustable in real time; and ω is the steady-state vibration frequency of the controlled main structure;

The natural frequency ω_{TMD} and the damping ratio ξ_{TMD} of the semi-active tuned mass damper are respectively:

ω_{TMD}=\sqrt{k_{eq}/m} (3)

ξ_{TMD}=c_{eq}/(2mω_{TMD}) (4)

where m is the mass of the mass block 1;

It can be seen from formula (1) that by adjusting the viscous damping coefficient c̅₂ of second damping element 4 in real time, the equivalent stiffness coefficient of the semi-active tuned mass damper can be adjusted in real time; when c̅₂=0, the equivalent stiffness coefficient of the semi-active tuned mass damper is

$${k}_{e q} = \frac{{k}_{1} {k}_{2}}{{k}_{1} + {k}_{2}} ;$$

when c̅₂→+∞, the equivalent stiffness coefficient of the semi-active tuned mass damper is k_{eq}=k₁; therefore, the equivalent stiffness coefficient of the semi-active tuned mass damper can be continuously adjusted between

$$\frac{{k}_{1} {k}_{2}}{{k}_{1} + {k}_{2}}$$

and k₁; when k₁=3k₂, the adjustable range of the equivalent stiffness coefficient k_{eq} of the semi-active tuned mass damper is from

$$\frac{{k}_{1}}{4}$$

to k₁, and correspondingly, the natural frequency ω_{TMD} of damper is from the semi-active tuned mass damper can be continuously adjusted between

$$\frac{\sqrt{{k}_{1} / m}}{2}$$

and \sqrt{k₁/m}; and by increasing the ratio between k₁ of the first elastic elements 3 and k₂ of the second elastic elements 5, the adjustable ranges of the equivalent stiffness coefficient k_{eq} of the semi-active tuned mass damper and the natural frequency ω_{TMD} of the semi-active tuned mass damper can be further expanded.

It can be seen from formula (2) that the changes in the viscous damping coefficient c̅₁ of the first damping element 2 and the viscous damping coefficient c̅₂ of the second damping element 4 will both influence the equivalent damping coefficient c_{eq} of the semi-active tuned mass damper. The adjustment of the viscous damping coefficient c̅₂ of the second damping element 4 not only alters the equivalent damping characteristics of a system but also causes changes in the equivalent stiffness coefficient. To avoid strong coupling between stiffness adjustment and damping adjustment and achieve independent and fine control of damping parameters, the equivalent damping coefficient of the semi-active tuned mass damper is mainly adjusted by adjusting the viscous damping coefficient c̅₁ of the first damping element 2.

The material and structural form of the mass block 1 are not limited, and the mass and size can be set according to the mass and vibration control requirements of a controlled structure.

The first damping element 2 can adopt an adjustable damping element such as a magnetorheological damper or a controllable liquid viscous damper, and the viscous damping coefficient can be adjusted under the action of external control signals. If a magnetorheological damper is adopted, adjustment is achieved by applying a current; the greater the current is, the greater the output damping force of the magnetorheological damper at a given speed is; and the viscous damping coefficient is also increased correspondingly. If a controllable liquid viscosity damper is adopted, adjustment is achieved by changing the permeability of a piston; the smaller the permeability is, the greater the damping force is; and the viscosity damping coefficient is also increased correspondingly.

The first elastic elements 3 can adopt helical tension springs or helical compression springs which are preferably made of spring steel wires, and the cross-sectional shape of each spring is preferably circular.

The second damping element 4 can adopt an adjustable damping element such as a magnetorheological damper or a controllable liquid viscous damper, and the viscous damping coefficient can be adjusted under the action of external control signals.

The second elastic elements 5 can adopt helical tension springs or helical compression springs which are preferably made of spring steel wires, and the cross-sectional shape of each spring is preferably circular.

The connecting element 6 shall have sufficient rigidity, strength and durability, and the material and structural form thereof are not specifically limited.

The limit element 7 shall have sufficient rigidity, strength and durability, and the material and structural form thereof are not specifically limited.

The present invention has the following beneficial effects: (1) by rationally combining the adjustable damping elements with the elastic elements, the real-time and continuous adjustment of the equivalent stiffness and equivalent damping parameters of the TMD is achieved without relying on complex mechanical structures or frequent mechanical switching; (2) the stiffness adjustment is achieved in a semi-active control mode, the energy consumption of the present invention during operation is relatively low, and no external energy is input to the controlled main structure, so that the operational safety and stability of the system are ensured; (3) the adjustable range of stiffness is large, which can adapt to significant changes in the vibration frequency of the main structure and the control requirements of multi-modal vibration; and (4) the present invention has a simple structural form, and the control strategy and control algorithm are easy to implement, with good engineering feasibility.

### DESCRIPTION OF DRAWINGS

FIG. 1 is a schematic diagram of a theoretical model of a semi-active tuned mass damper for horizontal vibration control;

FIG. 2 is a schematic diagram of a theoretical model of a semi-active tuned mass damper for vertical vibration control;

In the figures: 1 mass block, 2 first damping element, 3 first elastic element, 4 second damping element, 5 second elastic element, 6 connecting element, and 7 limit element.

### DETAILED DESCRIPTION

Specific embodiments of the present invention are described below in detail in combination with the technical solution and the drawings.

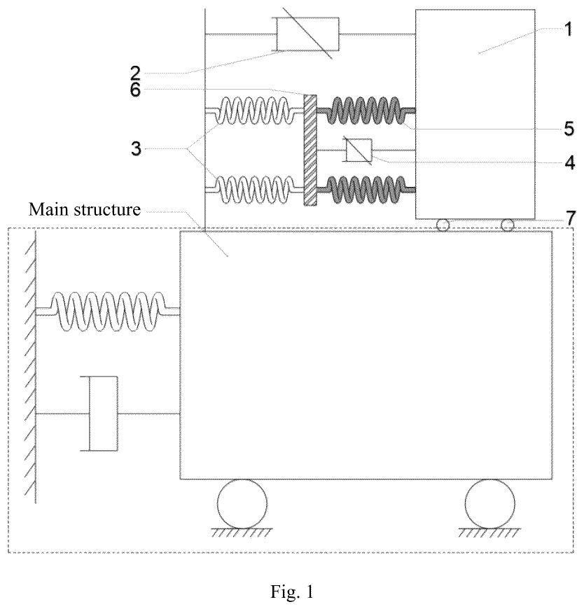

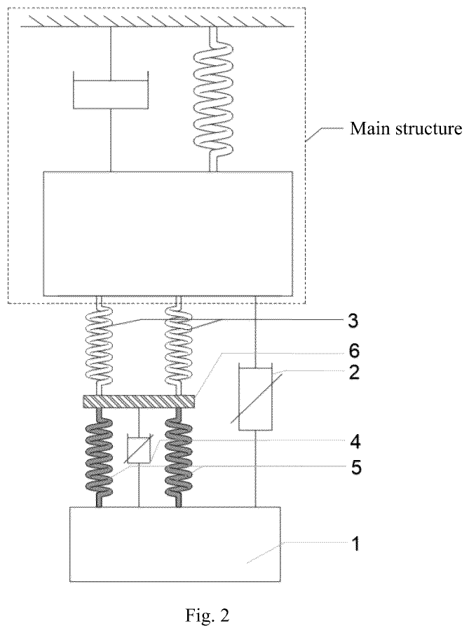

As shown in FIG. 1 and FIG. 2, a semi-active tuned mass damper with adjustable stiffness and adjustable damping comprises a mass block 1, a first damping element 2, first elastic elements 3, a second damping element 4, second elastic elements 5, a connecting element 6 and a limit element 7.

The mass block 1 is used for providing a tuned mass and is connected with a controlled main structure through an elastic subsystem and a damping subsystem, and the mass block 1 can make a relative movement in a predetermined direction relative to the controlled main structure.

The first damping element 2 is arranged between the mass block 1 and the controlled main structure, is used as the damping subsystem of the semi-active tuned mass damper, and has a viscous damping coefficient adjustable in real time.

The elastic subsystem is composed of the first elastic elements 3, the second damping element 4 and the second elastic elements 5, and is arranged between the mass block 1 and the controlled main structure. The second damping element 4 and the second elastic elements 5 are connected in parallel to form an elastic-damping combined component, and the elastic-damping combined component is connected in series with the first elastic elements 3.

The connecting element 6 is arranged between the elastic-damping combined component and the first elastic elements 3 to achieve a reliable connection between the two.

The limit element 7 is used for limiting the movement direction of the mass block 1 to prevent the mass block 1 from moving in an unexpected direction during vibration and ensure the operational safety of the device.

The semi-active tuned mass damper can be used for horizontal or vertical vibration control, and schematic diagrams of theoretical models thereof are shown in FIG. 1 and FIG. 2 respectively.

The equivalent stiffness coefficient k_{eq} of the elastic subsystem and the equivalent damping coefficient c_{eq} of the damping subsystem are respectively:

$${k}_{e q} = \frac{{k}_{1} [ {k}_{2} ( {k}_{1} + {k}_{2} ) + {( ω {\overline{c}}_{2} )}^{2} ]}{{( {k}_{1} + {k}_{2} )}^{2} + {( ω {\overline{c}}_{2} )}^{2}} \qquad ( 1 )$$

$${c}_{e q} = {\overline{c}}_{1} + \frac{{k}_{1}^{2} {\overline{c}}_{2}}{{( {k}_{1} + {k}_{2} )}^{2} + {( ω {\overline{c}}_{2} )}^{2}} \qquad ( 2 )$$

where k₁ and k₂ are respectively the stiffness coefficients of the first elastic elements 3 and the second elastic elements 5; c̅₁ and c̅₂ are respectively the damping coefficients of the first damping element 2 and the second damping element 4, and are both adjustable in real time; and w is the steady-state vibration frequency of the controlled main structure;
The natural frequency ω_{TMD} and the damping ratio ξ_{TMD} of the semi-active tuned mass damper are respectively:

ω_{TMD}=\sqrt{k_{eq}/m} (3)

ξ_{TMD}=c_{eq}/(2mω_{TMD}) (4)

where m is the mass of the mass block 1.

The above only describes preferred embodiments of the present invention and shall not be regarded as any form of limitation to the present invention. Any equivalent change, modification or improvement made to the above embodiments by those skilled in the art when utilizing the technical solution of the present invention shall be deemed to fall within the protection scope of the technical solution of the present invention.

1. A semi-active tuned mass damper with adjustable stiffness and adjustable damping, comprising a mass block, a first damping element, first elastic elements, a second damping element, second elastic elements, a connecting element and a limit element;
the mass block is used for providing a tuned mass and is connected with a controlled main structure through an elastic subsystem and a damping subsystem, and the mass block can make a relative movement in a predetermined direction relative to the controlled main structure;
the first damping element is arranged between the mass block and the controlled main structure, is used as the damping subsystem of the semi-active tuned mass damper, and has a viscous damping coefficient adjustable in real time;
the elastic subsystem is composed of the first elastic elements, the second damping element and the second elastic elements, and is arranged between the mass block and the controlled main structure; the second damping element and the second elastic elements are connected in parallel to form an elastic-damping combined component; and the elastic-damping combined component is connected in series with the first elastic elements;
the connecting element is arranged between the elastic-damping combined component and the first elastic elements to achieve the connection between the two;
the limit element is used for limiting the movement direction of the mass block to prevent the mass block from moving in an unexpected direction during vibration;
the equivalent stiffness coefficient k_{eq} and the equivalent damping coefficient c_{eq} of the semi-active tuned mass damper are respectively:
$${k}_{e q} = \frac{{k}_{1} [ {k}_{2} ( {k}_{1} + {k}_{2} ) + {( ω {\overline{c}}_{2} )}^{2} ]}{{( {k}_{1} + {k}_{2} )}^{2} + {( ω {\overline{c}}_{2} )}^{2}} \qquad ( 1 )$$
$${c}_{e q} = {\overline{c}}_{1} + \frac{{k}_{1}^{2} {\overline{c}}_{2}}{{( {k}_{1} + {k}_{2} )}^{2} + {( ω {\overline{c}}_{2} )}^{2}} \qquad ( 2 )$$
where k₁ and k₂ are respectively the stiffness coefficients of the first elastic elements and the second elastic elements; c̅₁ and c̅₂ are respectively the viscous damping coefficients of the first damping element and the second damping element, and are both adjustable in real time; and ω is the steady-state vibration frequency of the controlled main structure;
the natural frequency ω_{TMD} and the damping ratio ξ_{TMD} of the semi-active tuned mass damper are respectively:
ω_{TMD}=\sqrt{k_{eq}/m} (3)
ξ_{TMD}=c_{eq}/(2mω_{TMD}) (4)
where m is the mass of the mass block.

2. The semi-active tuned mass damper with adjustable stiffness and adjustable damping according to claim 1, wherein the first damping element adopts a magnetorheological damper or a controllable liquid viscous damper.

3. The semi-active tuned mass damper with adjustable stiffness and adjustable damping according to claim 1, wherein the first elastic elements and the second elastic elements adopt helical tension springs or helical compression springs which are made of spring steel wires, and the cross-sectional shape of each first elastic element is circular.

4. The semi-active tuned mass damper with adjustable stiffness and adjustable damping according to claim 1, wherein the second damping element adopts a magnetorheological damper or a controllable liquid viscous damper.
